(19) United States
(12) Patent Application Publication
(10) Pub. No.: US 2004/0139642 A1
(43) Pub. Date: Jul. 22, 2004

(54) Organization system for identifying instruments

(76) Inventors: James B. Johnsen, Beaverton, OR (US); Hal J. Oien, Tualatin, OR (US)

Correspondence Address: KOLISCH HARTWELL, P.C., 520 S.W. YAMHILL STREET, SUITE 200, PORTLAND, OR, 97204, US

(21) Appl. No.: 10/684,344

(22) Filed: Oct. 10, 2003

Related U.S. Application Data
(60) Provisional application No. 60/417,783, filed on Oct. 10, 2002.
(60) Provisional application No. 60/417,802, filed on Oct. 10, 2002.

(51) Int. Cl. G09F 3/18

(52) U.S. Cl. 40/661.11

(57) ABSTRACT

An identification tag for identifying instruments is provided, the identification tag including a body having an insertion portion configured to be inserted into an instrument-holding device and a labeling panel configured to be selectively marked with user-selected identification information.

### CROSS-REFERENCE TO RELATED APPLICATIONS

This application claims priority from U.S. Provisional Patent Application Serial No. 60/417,783 of James B. Johnsen and Hal J. Oien for INSTRUMENT IDENTIFYING TAGS, filed Oct. 10, 2002, and U.S. Provisional Patent Application Serial No. 60/417,802 of James B. Johnsen and Hal J. Oien for a FOAM FOR INSERTION CLEANING OF INSTRUMENTS, filed Oct. 10, 2002, the disclosures of which are hereby incorporated by reference.

### BACKGROUND

In various industries, users may select specialty instruments for use in a specific job or task. In some industries, such instruments further may be pre-identified for use and reuse in such specific job or task. By pre-identifying such instruments, a user may be able to quickly and effectively access the appropriate instruments while performing the job or task. For example, in the medical and dental fields, instruments for a particular procedure may be pre-identified to accommodate rapid access to such instruments during a procedure. Similarly, instruments for a particular patient may be identified or pre-identified to streamline the process of accessing an appropriate set of instruments during initial and/or follow-up visits.

In dentistry, it may be useful to identify different types of dental files. Such files, it will be appreciated, may have different lengths, and/or diameters, depending on the procedure and/or the patient's condition. Furthermore, different users may desire that instruments be arranged or organized in different ways. This may coincide with identification of such instruments for particular patients, procedures and/or uses.

Despite the foregoing, dental instruments have heretofore been difficult to label due to the size of such instruments. The need for autoclaving, or other sterilizing or cleaning processes, have further limited options for labeling of such instruments.

### BRIEF DESCRIPTION OF THE DRAWINGS

FIG. 1 is an isometric view of an exemplary instrument servicing system including an identification tag according to an embodiment of the present invention.

FIG. 2 are front views of two exemplary instrument servicing systems illustrating an organization system according to an embodiment of the present invention.

FIG. 3 is an enlarged front view of an exemplary identification tag for use in an instrument servicing system according to an embodiment of the present invention.

FIG. 4 is an exemplary packaging ring including a plurality of identification tags according to an embodiment of the present invention.

### DETAILED DESCRIPTION

Identification tags are disclosed herein for use in identifying a set of selected instruments or instrument sets. The identification tags may be used to identify instrument sets for use in a variety of industries, including, but not limited to, high-technology industries, medical industries, dental industries, etc. Although the following description illustrates the use of an organization system and identification tags in dental instrument servicing systems, it should be appreciated that similar identification tags may be used to identify instrument sets for use in other fields, including, but not limited to, other medical and high-technology fields.

For illustration purposes, exemplary dental instrument servicing systems are described and disclosed in the following patents and patent applications: U.S. Pat. No. 4,280,808 to Johnsen and Oien entitled “Endodontic File Holder” issued Jul. 28, 1981; U.S. Pat. No. 5,368,482 to Johnsen and Oien entitled “Dental Instrument Servicing System” issued Nov. 29, 1994; U.S. Pat. No. 6,036,490 to Johnsen and Oien entitled “Dental Instrument Servicing System” issued Mar. 14, 2000; and U.S. patent application Ser. No. 10/350,640 entitled “Porous Material for Insertion Cleaning of Instruments” filed Jan. 23, 2003. The foregoing disclosures are incorporated herein by this reference thereto.

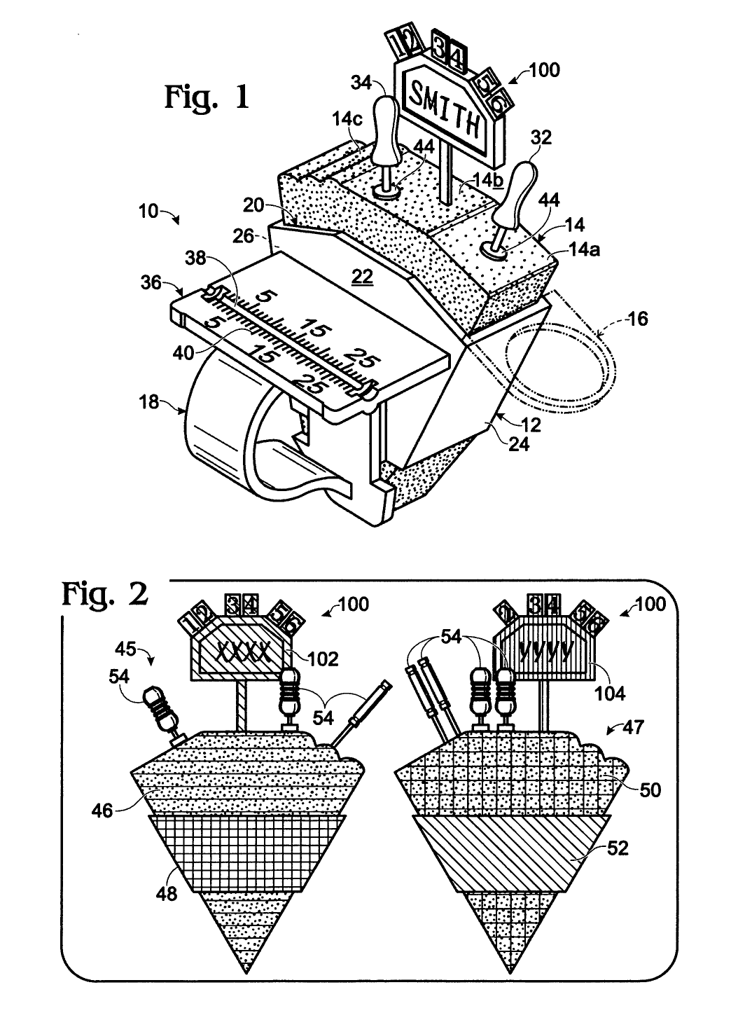

An exemplary dental instrument servicing system 10 is shown generally in FIG. 1. As shown, system 10 includes a socket-forming member 12, which in turn may carry an insert or cushion 14. Cushion 14 may be composed of any suitable material for use in holding instruments, such as endodontic dental files. For example, cushion 14 may be composed of foam or other porous material. The cushion may be used to both hold and clean instruments. Details of an exemplary cushion are provided in the aforementioned U.S. patent application Ser. No. 10/350,640, the disclosure of which has been incorporated herein by reference above.

In addition to holding the instruments, in some embodiments, cushion 14 further may be configured to receive one or more identification tags 100, described in detail below. Briefly, one or more identification tags 100 may be selectively inserted into cushion 14 to enable a user to identify or pre-identify an instrument or instrument set. It should be appreciated that identification tag 100 may be selectively positioned within cushion 14 such that the identification tag does not disrupt the placement or use of the instruments within the cushion. It should further be noted that a user may selectively remove or reposition identification tag 100 within cushion 14. Additionally, in some embodiments, the identification tag may be configured to be substantially secured within the cushion, such that the cushion, the instruments, and the identification tag may be steam auto-claved or otherwise cleaned, sterilized and/or manipulated.

The instrument servicing system of FIG. 1 may further optionally include a medicament holder 16 and/or a finger mount 18. The cushion, medicament holder and finger mount may be selectively removable from socket-forming member 12. Finger mount 18 may allow the system to be positioned on an individual's forefinger for use during a dental procedure. The finger mount may be removably attached to socket-forming member 12 via a cooperative slide arrangement, as described in previously-issued U.S. Pat. No. 4,280,808, which has been incorporated herein by reference above. Typically, such a system is relatively lightweight and is not appreciably more burdensome than a large ring. Thus, such a system typically will not significantly interfere with use of the instrument servicing system on a wearer's hand.

Socket-forming or socket-defining member 12 of instrument servicing system 10 may define a double-open-ended socket 20, which may provide a seat for cushion 14. Other configurations for socket-forming member 12 which retain cushion 14 are further considered and are within the scope of the disclosure. Although not required, the socket-forming member may be of unitary construction, being formed of a lightweight material, such as plastic or aluminum. These materials, it will be appreciated, typically are inexpensive, may be formed by molding processes, and may be suitable for hand-worn use.

Socket-forming member 12 may include plural walls that define socket 20. For example, socket 20 may be defined by front wall 22, side walls 24, 26 and back wall (not shown). Typically, the cushions are somewhat abrasive such that the abrasiveness of the cushion provides frictional adherence of the cushion to the walls of the socket-forming member. In some embodiments, cushion 14 may be removably inserted into socket 20 and retained by one or more of the walls of socket-forming member 12. Additionally, in some embodiments, projections (not shown) may extend outward from side walls 24, 26 and may provide frictional anchors, which may help to maintain cushion 14 within socket 20.

As illustrated, cushion 14 may be generally pie-shaped such that it conforms closely to the shape of the socket. However, it should be appreciated that cushion 14 may be any suitable shape depending on the type and/or configuration of the system.

In some embodiments, the upper end of socket-forming member 12 may be of a predetermined contour. For example, the socket-forming member may define a plurality of distinct regions, each of which may accommodate different servicing operations. The distinct regions may face in different angular directions,

Cushion 14 also may include a plurality of distinct cushion surface regions, such as regions 14a, 14b and 14c. These cushion surface regions may substantially mimic the contour of the upper end of the socket-forming member 12. Each cushion surface region may be adapted to receive instruments, such as dental files of various sizes and/or styles. Therefore, the system may be used to organize endodontic files, or other instruments, by placement of selected files into specific cushion surface regions.

In FIG. 1, for example, file 32 is placed in right-most region 14awhereas file 34 is in central region 14b. It should be noted that the cushion surface regions may include a substantially planar surface (as shown in reference to 14a and 14b) or may be contoured. Contoured surfaces may provide additional surface area for organizing and placing instruments. For example, cushion surface region 14c undulates, providing additional distinct regions for placing instruments.

Socket-forming member 12 of instrument servicing system 10 also may include an outwardly projecting shelf 36. The shelf may extend outward, covering finger mount 18, and thus may protect a user's finger from injury by sharp instruments, such as endodontic files, which may be inserted into the cushion. The shelf may further serve as a measuring device for use in connection with endodontic files. Thus, shelf 36 may include a trough 38 for receipt of endodontic files. A scale 40 may be etched into shelf 36, accommodating accurate positioning of depth markers on the file. The use of such a measuring device is more fully described in the aforementioned U.S. Pat. No. 4,280,808, which has been incorporated herein by reference above.

As briefly described above, medicament holder 16 may be removably applied to socket-forming member 12. Medicament holder 16 may include a cup section configured to hold a medicament in a dosage container and a clip section (not shown) configured to selectively attach the medicament holder to the socket-forming member.

Although not illustrated in FIG. 1, socket-forming member 12 further may include a service platform. The service platform may be adapted for receipt of depth markers 44 which may be used in connection with endodontic files 32, 34 (as shown in FIG. 1). In some systems, a depth marker may be applied to an endodontic file by insertion of the endodontic file through an aperture in the service platform.

FIG. 2 further illustrates an organization system including the use of identification tags, cushions and socket-forming members to enable a user to easily identify and organize instruments for use. Specifically, FIG. 2 illustrates two exemplary instrument servicing systems 45, 47, where each system includes a socket-forming member and a cushion. As used herein, the cushion and/or the socket-forming member may be considered an instrument-holding device. Specifically, the first instrument servicing system 45 includes a cushion 46 and a socket-forming member 48. The second instrument servicing system 47 includes a cushion 50 and a socket-forming member 52. It should be appreciated that the socket-forming member in both systems is optional and if included, may be of any suitable configuration.

As discussed above, cushions 46 and 50 may be used within dental servicing systems, such as the system described above, or may be stand-alone instrument holders. Instruments, such as dental files 54, may be selectively positioned and/or arranged within cushions 46, 50. For example, one or more instruments (also referred to herein as an instrument set) may be selected, stored and/or arranged within each cushion. The selection of the instrument set may be dependent on the intended use, the patient, the procedure, etc.

For illustrative purposes, three different dental files are shown positioned within cushion 46 in FIG. 2. The various cushion surface regions may be used to further organize the instruments. Similarly, multiple instruments are shown arranged in cushion 50. To identify the instrument set or the intended use of the instrument set, one or more identification tags 100 may be inserted into the cushions. Each identification tag may be selectively marked with user-selected identification information relating to the instrument set or use of the instrument set. For example, a user may selectively mark identification tag 102 with markings, such as “XXXX”, to indicate a patient, a date, a procedure, a file code, a type of instrument set, etc. A different identification tag, such as identification tag 104 inserted within cushion 50, may be marked with different information relating to the use of the instrument set within cushion 50. For example, identification tag 104, may be marked with different markings, such as “YYYY.” Such markings may be used to identify the corresponding instrument set.

It should be noted that in some embodiments, an organization system may be provided. The organization system may include visually-identifiable characteristics that may be used to aid in organizing and identifying instrument servicing systems and/or instrument sets. The visually-identifiable characteristics may be used to indicate a specific arrangement of instruments, such as files, which may enable a user to streamline a procedure. Such visually-identifiable characteristics may include any visual coding or other suitable visual characteristics. For example, the visually-identifiable characteristic or visual coding may include color coding, texture coding, symbol coding, labeling, etc. Thus, although the following exemplary description illustrates color coding the instrument serving systems, it should be appreciated that such description applies to other visual coding schemes.

As described above, color coding the instrument servicing systems may aid a user in organizing multiple instrument servicing systems and/or instrument sets. Thus, in some embodiments, one or more of the cushion, the socket-forming member and/or the identification tag may be colored to aid in easy identification of the type of cushion, system or instrument set. For example, different colors, such as yellow, green, purple, red, blue, etc. may be used to identify the cushion, the socket-forming member, the identification tag, and/or the instrument set.

The use of colors on one or more of the cushion, identification tags and/or servicing systems enables a user to develop a color code for ease of use and organization of the dental servicing systems and instruments sets. For example, in the illustrated embodiment, cushion 46 is shown as blue, while cushion 50 is shown as yellow. In some embodiments, the colors may indicate different types of cushions. Alternatively, the different colors may be used to identify different providers of the instrument sets, different classes of patients, different users, or different types of procedures to be performed with such instrument sets.

Similarly, the socket-forming members 48, 52 may be provided in one of multiple colors, such as, but not limited to, green, yellow, purple, blue, white, etc. These colors may correspond with cushion colors, or may be mutually exclusive to allow rapid identification of different features, provides characteristics or users of the instrument sets. In the illustrated embodiment, socket-forming member 48 is shown for exemplary purposes as yellow, while socket forming-member 52 is shown for exemplary purposes as green. The use of different colors for the socket-forming members or cushions may enable the assignment of a specific color to a doctor or other specialist. For example, if Doctor A is assigned green socket-forming members, and Doctor B is assigned yellow socket-forming members, a green socket-forming member may be easily identified as belonging to Doctor A and a yellow socket-forming member may be easily identified as belonging to Doctor B. Where cushion color indicates the type of procedure, a particular instrument set for a particular doctor may be readily identified for use. Alternatively, in some embodiments, the use of the different colors for the socket-forming members and/or cushions may be related to the particular instrument set, the patient, etc.

Similarly, color-coded identification tags may be used to identify a patient, a user, a clinic, an instrument set, etc. Thus, in FIG. 2, instrument tag 102 is shown for illustrative purposes as green and instrument tag 104 is shown for illustrative purposes as red. As described above, other colors or visually-identifying characteristics may be used to differentiate between multiple identification tags. The use of the different colors may enable easy identification of the instrument set.

It should be appreciated that a user may create a customized code where user-selected information correlates to the visually-identifiable characteristics of the cushion, identification tag and/or socket-forming member depending on the user's needs and/or desires. Moreover, although the socket-forming member, the identification tag and foam are all described as color-coded, it should be appreciated that in some embodiments, other visually-identifiable characteristics may be used alone or in combination with color-coding on one, two, three, or none of the socket-forming members, cushions, and/or identification tags.

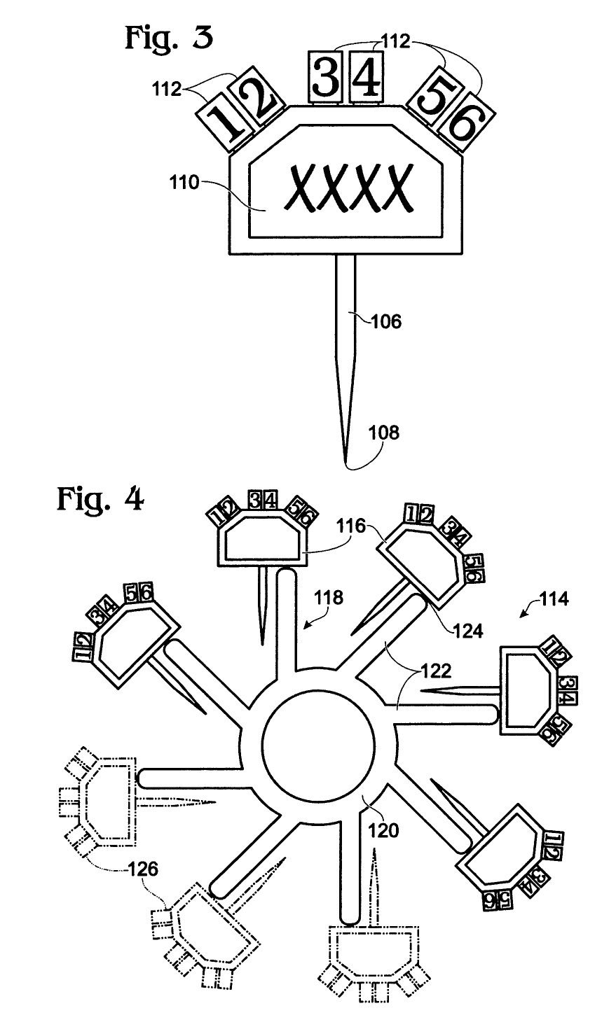

FIG. 3 further illustrates identification tag 100. As described above, in some embodiments, identification tag 100 may be configured to be inserted into an instrument-holding device. For example, identification tag 100 may include an insertion portion 106 adapted to enable a user to selectively position identification tag 100 within the instrument-holding device. In some embodiments, the insertion portion may include a pointed tip 108 adapted to puncture and pass into a cushion, such as a foam insert. Pointed tip 108 may penetrate the surface of the cushion and slide through the body of the cushion into the interior region such that the instrument tag is supported in an upright configuration adjacent the instrument set. It should be noted that in some embodiments, insertion portion 106 may be adapted to otherwise engage socket-forming member 12, such that the identification tag is associated with the instrument-holding device.

The identification tags may further include a labeling panel 110 configured to be selectively marked with user-selected identification information. For example, a user may use a marking instrument, such as a pen, to mark the labeling panel. Any suitable identification information may be marked on the labeling panel. For example, a user may include identification information, including, but not limited to, information regarding the identity of a patient, such as the patient's last name (as shown in FIG. 1), patient's first or full name, patient code, etc., the identity of a doctor or specialist, the identity of a clinic, the date of a procedure, file numbers, types of files etc.

In some embodiments, a user may mark the identification tag with a permanent marker or other indelible pen. The use of such pens may ensure that the markings are maintained during cleaning, sterilizing, and/or use of the instruments. In some embodiments, stickers or other suitable labels may be attached or otherwise secured to the labeling panel of the identification tags and may operate as user-selected identification information.

The user may mark and use the identification tags prior to a procedure, during a procedure or after a procedure. For example, prior to a procedure, a user may pre-load a cushion with dental files or other instruments of varying types, lengths or diameters, such files being specific to the patient, the doctor, or the intended procedure. Use of the identification tag enables a user to identify the preloaded cushion as intended for use on a specific patient, a specific doctor, and/or for a specific procedure, thereby streamlining the process. Similarly, during or after the procedure, the identification tag may be used to identify the instrument set for use in a follow-up visit or later procedure of the same patient.

In some embodiments, identification tag 100 may include a system for marking the number of times that an instrument set has been used. Specifically, some instruments may be used multiple times. For example, in dental procedures, instruments, such as dental files, may be used a determinate number of times. The number of uses of the instruments may depend upon the user's judgment, and tracking the numbers of uses may provide information regarding whether to continue use of a specific set of instruments.

Any suitable system for marking the number of uses of the instrument set may be provided on the identification tag. For example, identification tag 100 may include a plurality of use indicators or use tabs 112 which may be removed or marked to identify the number of times an instrument set has been used. For example, in the illustrated embodiment, identification tag 100 includes six removable and numbered tabs 112 detachably secured to the body of the identification tag. Although six tabs are illustrated, it should be appreciated that any number of suitable tabs may be provided on identification tag 100. Thus, in some embodiments, only two tabs may be provided, while in other embodiments, three, four, five, six, seven or more tabs may be provided. Further, in some embodiments, a single tab may be provided which may be marked by a user to identify the number of uses.

In the embodiment illustrated in FIG. 3, tabs 112 are adapted to be selectively removed from the body of identification tag 100. For example, the user may tear off a numbered tab from the body of identification tag 100 after each use. The user may then be able to easily identify the number of uses for the particular instrument set. For illustrative purposes, instrument servicing system 47 in FIG. 2, shows an identification tag 104, which identifies that the instrument set has been used once. Specifically, the removal of the first numbered tab from the identification tag may be used to indicate to a user that the instrument set has been used once. The user may then proceed using his/her judgment regarding whether to replace or reuse the instrument set based on the instrument usage.

Tabs 112 may further be used to indicate the number of times an instrument set has been steam autoclaved. Thus, a user may selectively track the number of uses of the instrument set by tracking the number of times a particular set has been steam autoclaved. Removal or marking of a tab provides an indicator to the user of information regarding the amount of use of the instrument set.

In some embodiments, the identification tags are manufactured of a resin that can be autoclaved in a standard steam autoclave. Typically, the resin will at least withstand a minimum of six uses. Thus, the identification tags may be configured to be autoclaved with the instruments ensuring identification of the instrument set after sterilizing. It should be noted that the configuration of the identification tag within the cushion may prevent the identification tag from being dislodged from the cushion during a normal autoclave process.

Any suitable method may be used to store and package the above-described identification tags. FIG. 4 illustrates an exemplary packaging method 114 for identification tags 116. Specifically, a packaging ring 118 may be provided including a central ring portion 120 and radial arms 122. Each identification tag 116 may be removably coupled to the radial arms via a release point 124. In such a configuration, a user may twist or otherwise rotate an identification tag secured to the radial arm, causing the release of the identification tag from the radial arm. Removal of individual identification tags, as indicated at 126, from the packaging ring does not disrupt the overall configuration of the packaging ring. It should be appreciated that the configuration of the packaging ring enables multiple packaging rings to be stacked and stored providing easy access to identification tags as needed. Because the identification tags are not individually stored, loss of individual identification tags may be minimized. Although an exemplary packaging ring is illustrated, it should be appreciated that other methods of storing and packaging the identification tags may be used without departing from the scope of the disclosure.

While the present description has been provided with reference to the foregoing embodiments, those skilled in the art will understand that many variations may be made therein without departing from the spirit and scope defined in the following claims. The description should be understood to include all novel and non-obvious combinations of elements described herein, and claims may be presented in this or a later application to any novel and non-obvious combination of these elements. The foregoing embodiments are illustrative, and no single feature or element is essential to all possible combinations that may be claimed in this or a later application. Where the claims recite “a” or “a first” element or the equivalent thereof, such claims should be understood to include incorporation of one or more such elements, neither requiring, nor excluding, two or more such elements.

What is claimed is:

1. A tag for identifying instruments, the tag comprising:
a body having:
an insertion portion configured to be received within an instrument-holding device; and
a labeling panel configured to be selectively marked with user-selected identification information.

2. The tag of claim 1, wherein the instrument-holding device includes a cushion, and the insertion portion is configured for receipt within the cushion.

3. The tag of claim 1, wherein the labeling panel is adapted to be selectively marked with a marking instrument.

4. The tag of claim 1, wherein the user-selected identification information is client-identity information.

5. The tag of claim 1, wherein the user-selected identification information is provider-identity information.

6. The tag of claim 1 further comprising at least one use tab configured to indicate instrument usage.

7. The tag of claim 6, wherein the at least one use tab is removable.

8. The tag of claim 1, wherein the body is adapted to withstand a steam autoclave.

9. The tag of claim 1, wherein the body is color-coded.

10. The tag of claim 1, wherein the body may be selectively released from a packaging ring.

11. An identification tag for a dental servicing system configured to receive instruments, the identification tag comprising:
an insertion portion configured to be removably inserted within a cushion of the dental servicing system;
a labeling portion configured to be selectively marked with user-selected identification information; and
a use tab configured to indicate instrument usage.

12. The identification tag of claim 11, further comprising a plurality of removable use tabs, wherein each use tab may be selectively removed to indicate the number of times the instruments have been used.

13. The identification tag of claim 11, wherein the insertion portion is configured to be substantially secured within the cushion adjacent the instruments.

14. The identification tag of claim 11, wherein the identification tag is configured to withstand steam autoclaving.

15. An identification tag for identifying an instrument set, the identification tag comprising:
means for positioning the identification tag substantially adjacent an instrument set;
means for selectively labeling the identification tag with identification information.

16. The identification tag of claim 15, further comprising a means for indicating the number of uses of the instrument set.

17. A method of organizing an instrument set, the method comprising:
selecting an instrument-holding device;
selecting a visually-coded identification tag; and
inserting the visually-coded identification tag into the instrument-holding device to identify an instrument set within the instrument-holding device.

18. The method of claim 17, wherein the instrument-holding device includes a cushion and a socket-forming member and wherein selecting an instrument-holding device includes selecting at least one of a visually-coded cushion and a visually-coded socket-forming member.

19. The method of claim 16, wherein selecting a visually-coded identification tag includes selecting a color-coded identification tag.

20. The method of claim 16, further comprising marking the visually-coded identification tag with user-selected identification information.

21. A kit for organizing instrument sets, the kit comprising:
a visually-coded instrument-holding device; and
a visually-coded identification tag, wherein the visually-coded identification tag is adapted to be received within the visually-coded instrument-holding device.

22. The kit of claim 21, wherein the instrument-holding device includes at least one of a color-coded cushion and a color-coded socket-forming member.

23. The kit of claim 21, wherein the visually-coded identification tag includes a labeling panel configured to be selectively marked with user-selected identification information.

24. The kit of claim 21, wherein the visually-coded identification tag is color coded.
